(19) United States
(12) Patent Application Publication
(10) Pub. No.: US 2014/0047859 A1
(43) Pub. Date: Feb. 20, 2014

(54) System For Forming Frozen Liquids

(71) Applicant: Kyle E. E. Schwulst, Whitmore Lake, MI (US)

(72) Inventor: Kyle E. E. Schwulst, Whitmore Lake, MI (US)

(21) Appl. No.: 13/585,164

(22) Filed: Aug. 14, 2012

(51) Int. Cl. F25C 1/22; B29C 35/00; B29C 51/42

(52) U.S. Cl. 62/340; 425/384; 425/144

(57) ABSTRACT

A system for forming frozen liquids is disclosed in which a device with first and second dies cooperate to form a frozen liquid preform into a frozen shape with indicia marked into the frozen shape. The device forms the frozen shape such that it maintains the indicia portion facing substantially upwards when the frozen shape floats in a liquid. The device may have warming fins, heat transfer passages, air and liquid passages, or temperature controlled electric heaters to aid on the forming of the frozen shape. The system may also include a frozen shape remover, a drip tray, or a frozen liquid preform tray.

### BACKGROUND

1. Field

Embodiments of the present invention relate to the forming of frozen liquids, and in particular, the melting of ice or frozen juice preforms into a shape to be placed into a drink.

2. Background Art

Ice has been placed into drinks and used to cool the drinks for many years. The ice used to cool drinks has traditionally been formed by filling an ice cube tray with water, freezing the water into cube shapes, and then removing the ice cubes from the tray and placing them in the drink. Freezing of the water into a shape takes time and the shapes may be limited by gravity and the expansion of water as it freezes.

Melting a frozen block if ice into a shape can be much quicker than freezing water into a shape, in addition there is no expansion of the material nor is the material as impacted by gravity during the melting process. An example of a melting device may be found in U.S. Pub. No. 2012/0007264 A1 to Kondou et al.

### SUMMARY

In one embodiment, a system for forming frozen liquids is disclosed in which the frozen liquid has an indicia portion in the shape. The system has a first die and a second die. The first die has a first interior surface defining a first cavity section. The second die has a second interior surface defining a second cavity section. The system has an indicia marker disposed within the first die along the first interior surface. The first and second dies are capable of cooperating to form a frozen liquid preform into a frozen shape corresponding to the first and second cavity sections. The resulting frozen shape will also have the indicia portion formed by the indicia marker. In addition, the dies cooperate to form a frozen shape that maintains the indicia portion facing substantially upwards when the frozen shape floats in a liquid.

In another embodiment, an apparatus for melting frozen liquid preforms into a shape is disclosed in which the apparatus has warming fins. The device has a first die and a second die, with each die having respective interior surfaces which define respective portions of an interior cavity of the die set when the dies come together. In this embodiment, at least one of the first and second dies has an outer surface defining warming fins to increase surface area and heat transfer from the respective die to the ambient environment as the dies melt the frozen liquid preform.

In yet another embodiment, a device for melting a frozen liquid preform into a shape is disclosed in which the device has heat transfer passages to aid in the heat transfer during the melting process. This device has first and second dies each with a respective interior surface defining a portion of the die cavity. The heat transfer passages may circulate in or around the dies, but they do not come into fluid communication with the die cavity.

In yet a further embodiment, a device for melting a frozen liquid preform into a shape is disclosed in which the device has a heating element to aid in the heat transfer during the melting process.

### BRIEF DESCRIPTION OF THE DRAWINGS

Embodiments of the present invention described herein are recited with particularity in the appended claims. However, other features will become more apparent, and the embodiments may be best understood by referring to the following detailed description in conjunction with the accompanying drawings, in which:

FIG. 1 is a perspective view of a first die and a second die in an open position showing an embodiment in which both dies have warming fins;

FIG. 2 is a cross-section view of a first and second die in an open position with a frozen liquid preform disposed between the two dies showing an embodiment in which an indicia marker is disposed within the first die and the second die defines a heat transfer passage;

FIG. 3 is a cross-section view of a first and second die in a closed position showing an embodiment in which the dies have formed a frozen liquid preform into a frozen shape and an indicia marker has formed an indicia portion of the frozen shape, the first die defining an air passage, the second die defining a liquid passage, and a heating element disposed in the second die;

FIG. 4 is a perspective view of an embodiment of an indicia marker;

FIG. 5 is a diagrammatic view of a frozen shape having a flat upper indicia portion above a water line;

FIG. 6 is a perspective view of a suction bulb device to facilitate the removal of a frozen shape from a die;

FIG. 7 is a perspective view of a drip tray; and

FIG. 8 is a perspective view of a frozen liquid preform tray.

### DETAILED DESCRIPTION

As required, detailed embodiments of the present invention are disclosed herein; however, it is to be understood that the disclosed embodiments are merely examples and that the invention may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

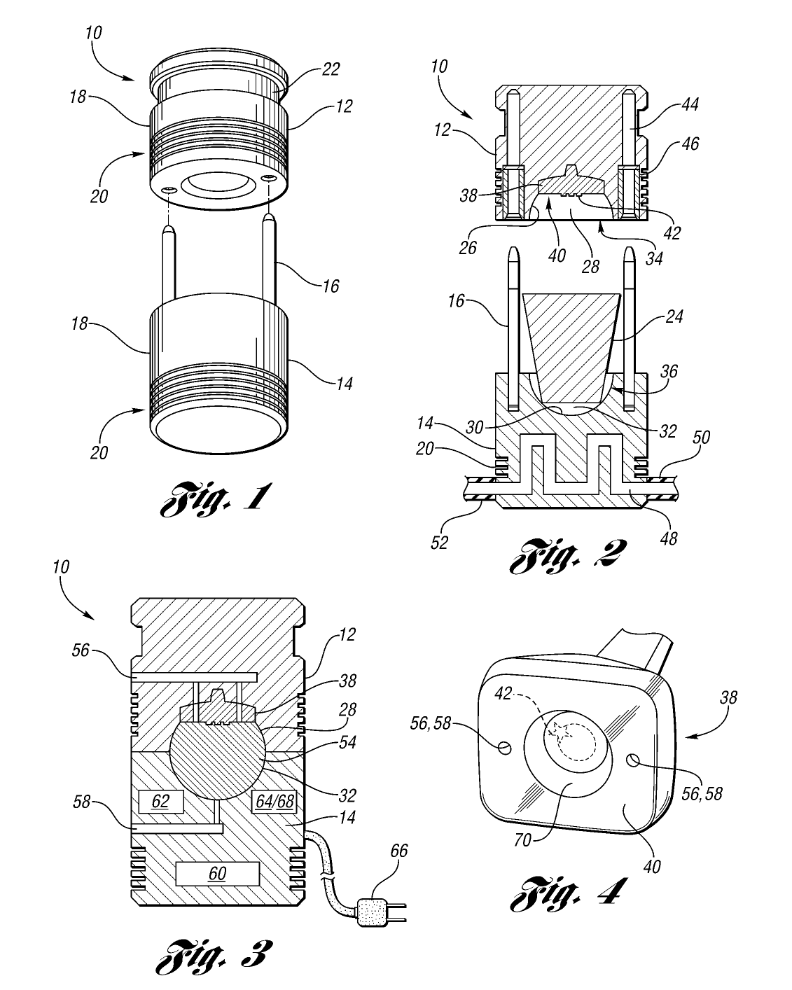

Referring to FIG. 1, an embodiment of a device 10 for melting a frozen liquid preform is shown. In this embodiment, a first die 12 and a second die 14 are shown in an open position. An open position allows for a frozen liquid preform to be placed between the dies 12, 14, or for a final formed shape to be removed from the dies 12, 14. In an open position, the dies 12, 14 may remain connected or be completely separated as shown here. The device may include one or more guides, or pins 16, that align the dies 12, 14 when opening and closing. The guides may be located within the dies 12, 14, as shown here, or may be external to the dies.

A die 12, 14 may have an outer surface 18 defining at least one warming fin 20. Warming fins 20 increase the surface area of the outer surface 18 and increase the heat transfer from the respective die 12, 14 to the ambient environment. As well, warming fins 20 aid in the increased heat transfer from the respective die 12, 14 when placed under running tap water, or submerged into a sink of water. These techniques are useful to increase the temperature of the dies 12, 14 after using the device to form a frozen shape allowing for the further forming of frozen liquid preforms to occur faster.

FIG. 1 also shows an embodiment in which the outer surface 18 defines a handle region 22. The handle region may be designed to be part of the die so as to allow easy separability of the two dies by hand, and may also act as a heat transfer enhancement by using body heat of the user to warm the die when grasped. The handle region 22 may be formed into the first die 12, the second die 14, both dies 12,14, or may be a separate handle attached to one or both dies 12, 14.

Referring to FIG. 2, a cross-sectional view of another embodiment of a device 10 is shown. In this view, the first die 12 is shown in an open position relative to the second die 14 with a frozen liquid preform 24 disposed between the two dies 12, 14. The frozen liquid preform 24 may be clear frozen water such as a clear ice. The frozen liquid preform may also be colored, such as by placing food coloring in water and freezing the water into a colored ice. The frozen liquid preform may also be produced by freezing beverages such as tea or lemonade. By placing colors or flavors into the frozen liquid preform, as the frozen shape melts into a drink it may change the color or flavor of the drink.

The first die 12 defines a first interior surface 26 which defines a first cavity 28. In this embodiment, the first cavity 28 is shown as being substantially hemispherical, although other shapes may be used. Similarly, the second die 14 defines a second interior surface 30 which defines a second cavity 32, and the second cavity 32 is shown as being substantially hemispherical, although other shapes may be used. In this figure, the parting line for the dies 12, 14 appears at the center of a spherical cavity defined by the first and second cavities 28, 32. In this embodiment, the first cavity 28 has a first volume 34 smaller than volume of the second cavity 32.

In this embodiment, an indicia marker 38 is shown disposed in the first die 12 at the top of the first cavity 28 and along the first interior surface 26. The indicia marker 38 may have a flat surface 40 although many different shapes may be used, including, but not limited to, wavy surfaces, parallel lined surfaces, or criss-crossed lined surfaces. The indicia marker 38 may also have raised indicia 42 which may form an indented mark into the frozen liquid preform 24 as it melts. It is also envisioned that recessed indicia may also be used which would form a raised mark on the frozen liquid preform 24, or any combination of raised and recessed indicia markers may be used. The indicia marker 38 may be removable from the first die 12, such that other markers may be swapped out in the device and multiple frozen shapes with differing indicia may be produced.

Indicia 42 may consist of alpha-numeric combinations, such as, but not limited to, a person's name, product name, business name, telephone number, postal address, or website address. Indicia may also include a geometric shape, symbol or design, such as a star, person's face or product trademark, or any combination of the above. As well, when the indicia marker 38 is used in combination with a colored frozen liquid preform 24, and then placed into a beverage with a clear, different, or similar colored appearance, the coloring of the frozen liquid preform 24 may enhance the marked indicia making the marked indicia more visibly appealing.

The cross-sectional view of FIG. 2 is taken through a pair of pins 16 housed in the second die 14. In this embodiment, the first die 12 defines a pair of pin receiving holes 44 and pin bushings 46 disposed within the receiving holes. The pin bushings 46 are not necessary for the device to function, however they provide a smoother transition of the dies 12, 14 when opening and closing.

Also shown diagrammatically in this cross-sectional view are heat transfer passages 48. Heat transfer passages 48 may be connected to a tap water line 50 in which water, or a heat transfer fluid, may be circulated through the die 14 enhancing heat transfer as the frozen liquid preform 24 melts. The die may also have a discharge line 52 that returns the tap water back to a drain. The heat transfer passages 48 may run in any direction within one or both of the dies, or even outside or around the dies, so long as the heat transfer passages 48 remain offset from the die cavities 28, 32.

Referring to FIG. 3, a cross-sectional view of yet another embodiment of a device 10 is shown. In this view, the first and second dies 12, 14 are shown in a closed position in which a frozen liquid preform 24 (see FIG. 2) has been formed into a frozen shape 54. The frozen liquid preform 24 is formed by the first and second cavities 28, 32, and the indicia marker 38. In this cross-sectional view, the first die 12 defines an air passage 56 and the second die 14 defines a liquid passage 58. Air and liquid passages 56, 58 are in fluid communication with the die cavities 28, 32 and aid in the removal of melted preform and trapped air during the forming process. The air and liquid passages may also aid in the opening of the dies 12, 14 after forming the frozen shape 54 by reducing the tendency of the dies to hydrolock or vacuum-lock together with a formed frozen shape inside. More than one air passage 56 and liquid passage 58 may be used, and both may be located in either die 12, 14.

A heating element 60 may be placed within a die 12, 14. The heating element 60 in combination with a temperature sensor 62 and a controller 64 are diagrammatically shown disposed in the second die 14. Although the three components are all shown in a single die, it is envisioned that the components may be placed within or along the outside of either die 12, 14. As well multiple heating elements 60, temperature sensors 62, or controllers 64 may be employed. In this embodiment, the heating element 60 is an electric heating element. The controller 64 may be a proportional integral derivative (PID) controller, although other controllers may be used, that is in communication with the temperature sensor 62 and the heating element 60 to automatically modulates the heating element 60 depending on the temperature measurements.

An AC power plug and cord 66 are diagrammatically shown in FIG. 3 to indicate a source of power for the controller 64, temperature sensor 62, and heating element 60, although other sources of AC or DC power may be used. One such alternative embodiment envisioned is the use of replaceable batteries (not shown). Another such alternative embodiment would be the use of rechargeable batteries or other electric storage devices (not shown). In the case of rechargeable batteries, an AC power plug 66 may be employed to charge the batteries, or inductive charging may be used by placing the device 10 on an inductive charging pad (not shown).

A thermostat 68 may be used in place of the controller 64 and temperature sensor 62 to switch the heating element 60 on or off depending on a set point of the thermostat 68. As above, multiple thermostats 68 in combination with multiple heating elements 60 may be used. The thermostat 68 and/or controller 64 may come with set control points, a set temperature, or a set temperature range, and may also allow modulation of the control points/temperatures by the user of the device 10.

Referring to FIG. 4 an embodiment of an indicia marker 38 is shown. In this embodiment the indicia marker 38 has a substantially flat surface 40, a recessed portion 70 having raised indicia 42 diagrammatically shown in the shape of a star and circle design. The indicia marker 38 also has air or liquid passages 56, 58 to aid in the removal of melted preform and trapped air during forming of the frozen shape 54. Although shown in this FIGUIRE, air and liquid passages 56, 58 do not have to pass through the indicia marker 38.

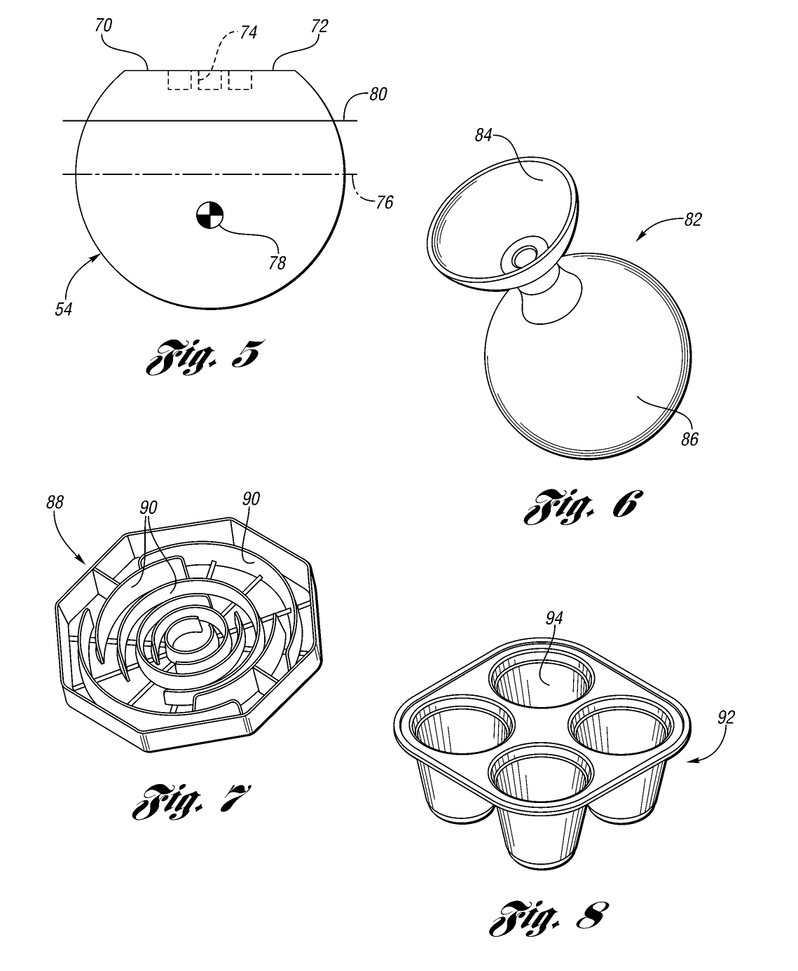

Referring to FIG. 5 an embodiment of a frozen shape 54 is shown. The frozen shape 54 is substantially spherical with an indicia portion 70 shown at the top. In this embodiment, the indicia portion 70 has a substantially flat side or region 72 creating a spherical cap removed from a side of the sphere. Recessed indicia 74 is shown formed into the frozen shape 54 in the center of the flat region 72. The frozen shape 54 is shown with a centerline 76 of what would have been the center of a spherical object if the spherical cap had not been removed. The removal of the spherical cap moves the center of gravity 78 below the centerline 76 and directly below the center of the flat region 72 and the indicia 74 formed into the frozen shape 54. As shown here, the center of gravity 78 is opposite the centerline 76 from the indicia 74.

The line where the frozen shape 54 meets the surface of a liquid it is floating in is called a waterline 80, and is shown substantially parallel and adjacent to the flat region 72. The center of gravity 78 being below the flat region 72 and below the center line 76 causes the frozen shape 54 to float in a drink with the indicia portion 70 facing upwards. Heat transfer from the frozen shape 54 to the drink in which it is floating in may occur more rapidly than from the frozen shape 54 to the air. The substantially spherical nature of the frozen shape 54, especially that which is submerged in a liquid, allows for a substantially uniform melting of the frozen shape 54 into the drink, leaving the indicia marking at the top and visible to the drinker of the drink while the frozen shape 54 melts. Although the frozen shape 54 is shown as being substantially spherical, other shapes may be used such that the shape may be formed by the dies 12, 14 and that the shape provides for the indicia portion 70 or the marked indicia 74 to appear above the waterline 80 when the frozen shape 54 is floating in a liquid.

Referring to FIG. 6 an embodiment of a frozen shape remover 82 is shown. The frozen shape remover 82 has a receiving surface 84 substantially similar in shape to a portion of at least one of the first or second cavities 28, 32 (see FIG. 3). The frozen shape remover 82 also has a suction bulb 86 in fluid communication with the receiving surface 84. The receiving surface 84 may be placed over a portion of the frozen shape 54 (see FIG. 5), the suction bulb 86 may be squeezed pushing air out past the edges of the frozen shape 54, and in combination with the receiving surface forming a seal around a portion of the frozen shape 54, creating a vacuum between the receiving surface 84 and the frozen shape 54. The vacuum between the receiving surface 84 and the frozen shape 54 allows for the frozen shape 54 to be easily moved, such as removing the frozen shape from the dies 12, 14 and placing it into a drink, while maintaining thermal insulation from the user to the frozen shape 54. The suction bulb 86 may also have a vacuum release hole (not shown) which the user may place a finger over while using the bulb and then release to remove the vacuum and allow the frozen shape 54 to more easily disengage from the receiving surface 84.

Referring to FIG. 7 an embodiment of a drip tray 88 is shown. The drip tray 88 is shown with a number of centering rings 90. As the frozen liquid preform 24 (see FIG. 2) melts into the frozen shape 54 (see FIG. 3), melted water from the preform may run down the exterior surface of the device 10, or out from a liquid passage 58, and the drip tray may collect the melting liquid. The centering rings 90 may have differing heights in which the rings on the outer radial distance are higher than the centering rings closer to the center. The heights of the centering rings 90 serve at least two purposes, one being to center devices 10 with different diameters, and the second being to provide enough space between the bottom die and the pooling melted liquid such that the die does not touch the liquid once it has melted from the frozen liquid preform 24. By spacing the device away from the melted liquid, the thermal efficiency of the device may be enhanced and controlled with greater ease.

Referring to FIG. 8 an embodiment of a frozen liquid preform tray 92 is shown. The frozen liquid preform tray 92 has at least one third cavity 94 in which a liquid may be filled and subsequently frozen. The third cavity 94 has a volume larger than the combination of the first and second cavities 28, 32 of the device 10 to which it is used with. The third cavity 94 being larger than the first and second cavities 28, 32 ensures the dies 12, 14 have enough frozen liquid preform 24 (see FIG. 2) material to form into the frozen shape 54 (see FIG. 3). The third cavity 94 may be tapered to allow for an easier removal of the frozen liquid preform 24. The frozen liquid preform tray 92 shown here has four third cavities 94, although any number of third cavities may be employed. As well, the third cavities may have markings on the side to indicate the size of a device 10 to which to fill the third cavity up to for the optimal size of a frozen liquid preform 24 for that specific size device 10.

While embodiments of the invention have been illustrated and described, it is not intended that these embodiments illustrate and describe all possible forms of the invention. Rather, the words used in the specification are words of description rather than limitation, and various changes may be made without departing from the spirit and scope of the invention.

What is claimed is:

1. A system for forming frozen liquids, the system comprising:
a first die having a first interior surface defining a first cavity section and an indicia marker disposed within the first die along the first interior surface; and
a second die having a second interior surface defining a second cavity section;
wherein the first and second dies are capable of cooperating to form a frozen liquid preform into a frozen shape corresponding to the first and second cavity sections, the frozen shape having an indicia portion formed by the indicia marker where the frozen shape as formed orients the indicia portion facing substantially upwards when the frozen shape is floated in a liquid.

2. The system of claim 1, wherein the frozen shape has a waterline when the frozen shape floats stilly in the liquid and a center of gravity orientation which locates the indicia marked portion above the waterline.

3. The system of claim 1, wherein the first and second cavities are substantially hemispherical and the indicia marker has a substantially flat region reducing a first volume of the first cavity to be smaller than a second volume of the second cavity forming a substantially spherical frozen shape with a substantially flat side having the indicia and the center of gravity of the spherical frozen shape is opposite of a centerline from the flat side.

4. The system of claim 1, wherein the indicia marker has raised indicia which melts the indicia portion into the frozen liquid preform as the dies form the frozen liquid preform into the frozen shape.

5. The system of claim 1, wherein the indicia marker is removable from the first die.

6. The system of claim 1 further comprising at least one of the first and second dies defining an air passage to allow air to escape the respective cavity while the frozen shape is formed.

7. The system of claim 1 further comprising at least one of the first and second dies defining a liquid passage to allow liquid to escape the respective cavity while the frozen shape is formed.

8. The system of claim 1 further comprising at least one of the first and second dies having an outer surface defining warming fins to increase surface area and heat transfer from the respective die to the ambient environment.

9. The system of claim 1 further comprising at least one of the first and second dies having an outer surface with a portion of the outer surface defining a handle region.

10. The system of claim 1 further comprising at least one of the first and second dies defining heat transfer passages within the respective die wherein the heat transfer passages are offset from the respective cavity.

11. The system of claim 10 further comprising a tap water line in fluid communication with the heat transfer passages for circulating water through the heat transfer passages.

12. The system of claim 1 further comprising a heating element disposed in at least one of the first and second dies.

13. The system of claim 12 further comprising a thermostat connected to the heating element for automatically turning on the heating element when at least a portion of at least one of the first and second dies is below a set temperature.

14. The system of claim 1 further comprising a drip tray disposed under the first and second dies.

15. The system of claim 14, wherein the drip tray has centering rings for receiving at least one of the first and second dies and substantially centering the respective die on the drip tray.

16. The system of claim 1 further comprising a frozen shape remover having a receiving surface and a suction bulb, wherein the receiving surface is substantially similar in shape to a portion of at least one of the first and second cavities and the suction bulb is in fluid communication with the receiving surface, such that the receiving surface is capable of being placed against the frozen shape forming a seal such that the suction bulb is capable of producing a vacuum between the frozen shape of the frozen shape remover facilitating the removal of the frozen shape from at least one of the dies.

17. The system of claim 1 further comprising a frozen liquid preform tray defining a third cavity, wherein the third cavity has a volume larger than a combination of the volumes of the first and second cavities such that the frozen liquid preform tray is capable of receiving a liquid into the third cavity, forming the liquid into a frozen liquid preform that has a volume larger than the first and second cavities combined volume and ensures that the dies have enough frozen liquid preform material to form into the frozen shape.

18. The system of claim 1, wherein the frozen liquid preform is ice.

19. The system of claim 1, wherein the frozen liquid preform is a colored frozen liquid preform such that the indicia marked on the frozen shape is more visibly appealing.

20. A device for melting frozen liquid preforms into a shape, the device comprising:
a first die having a first interior surface defining a first cavity;
a second die having a second interior surface defining a second cavity; and
at least one of the first and second dies having an outer surface defining warming fins to increase surface area and heat transfer from the respective die to the ambient environment.

21. The device of claim 20 further comprising at least one of the first and second dies defining an air passage to allow air to escape the respective cavity while the frozen liquid preform melts into a shape.

22. The device of claim 20 further comprising at least one of the first and second dies defining heat transfer passages within the respective die wherein the heat transfer passages are offset from the respective cavity and circulate a heat transfer fluid to increase the heat exchange capability of the respective die.

23. The device of claim 20, further comprising and indicia marker disposed within the first die adjacent to the first interior surface for marking indicia into the melting frozen liquid preform, wherein the first and second dies cooperate to melt a frozen liquid preform into a shape having an indicia marked portion which faces substantially upwards when the shape floats in a liquid.

24. The device of claim 23, wherein the indicia marker is removable from the first die.

25. The device of claim 23, wherein the indicia marker has raised indicia which melts indicia into the frozen liquid preform as the dies melt the frozen liquid preform into a shape.

26. A device for melting a frozen liquid preform into a shape, the device comprising:
a first die having a first interior surface defining a first cavity;
a second die having a second interior surface defining a second cavity; and
a heating element disposed in at least one of the first and second dies.

27. The device of claim 26, further comprising a temperature sensor disposed within at least one of the first and second dies in communication with the heating element.

28. The device of claim 27 further comprising a PID controller in communication with the temperature sensor and the heating element for automatically turning the heating element on and off depending on the temperature range as communicated by the temperature sensor.

29. The device of claim 26, further comprising an indicia marker disposed in the first die for melting indicia into the melting frozen liquid preform.
